(19) United States
(12) Patent Application Publication
(10) Pub. No.: US 2020/0036705 A1
(43) Pub. Date: Jan. 30, 2020

(54) STRONG PASSWORD BY CONVENTION METHODS AND SYSTEMS

(71) Applicant: Jasper Chee Pang LEE, Hong Kong (HK)

(72) Inventor: Jasper Chee Pang LEE, Hong Kong (HK)

(21) Appl. No.: 16/047,016

(22) Filed: Jul. 27, 2018

(51) Int. Cl. H04L 29/06; G06F 21/46; G06F 17/30; H04L 9/32

(52) U.S. Cl. CPC H04L 63/0838; G06F 21/46; H04L 9/3228; G06F 17/30575; H04L 63/20

(57) ABSTRACT

Disclosed LTS strong password by convention systems include a password designation system, a portable password devices and other systems. Disclosed portable device include age-sensitive display systems to ensure that passwords and their replicas do not get forgotten or otherwise become stale. Portable devices include sophisticated electronics to commutate with a pet owner, including means of communication not requiring the use of a smart phone. Portable devices may include a base collar containing a microprocessor and other computer related components. Password rule engine support flexible password definition by means of pseudorandom expressions and may be adjusted as needed by an owner or subject systems. Disclosed device functions are executed by the disclosed portable devices and facilitate long-term password replication and policy-driven password maintenance.

### FIELD OF THE INVENTION

The invention generally relates to enterprise security management. More particularly, the invention relates to systems and methods of strong password replication and designation.

### BACKGROUND OF THE INVENTION

Maintaining password replication levels is a fundamental process of enterprise authentication systems; replicas must be created as storage permanently fail to avoid data loss. Many failures in enterprise authentication are transient, however, where the failures are caused not by storage data loss but by disconnection between password storage and remote users.

Password management of the prior art fail to provide effective means of communicating among trusted parties in the event that passwords and their replicas become expired or otherwise forgotten. Prior art systems fail to provide automated support for passwords that are strong, industry standards driven, and at the same time memorable to average users even without the device being available. Long-term support (LTS) is a type of special versions or editions of software designed to be supported for a longer than normal period. It is particularly applicable to password management systems. Long-term support extends the period of password maintenance; it also alters the type and frequency of password updates (renewals) to reduce the risk, expense, and disruption of system accessibility. For example, large organizations, or users with mission critical passwords, often prefer to minimize disruption by retaining the same version of passwords for an extended period to the fullest extent allowed by password policies. For these types of users, unplanned password reset by e.g. a subject system or website, is often expensive. Updating a few selected passwords in a LTS large password set may introduce anomalies to an otherwise consistent password convention that is memorable to average users. Further, for example in an enterprise environment, changing passwords may require the cooperation of many people or stakeholders of a system.

It is not uncommon that occasionally subject systems or websites force password rules that are comparatively weaker than complexity requirements built into a password device. For example, a password device may be configured to support strong password rules where a password is considered strong only if the password includes one or more special characters. In situations such as the above example where a password has a different complexity level than that of a device's, a sensible thing to do is for the device to accept the weak password from a usability standpoint, which is what most prior art systems do. The problem lies in the fact that the built-in strong password rules are too rigid, and are typically not designed to be extensible in order to adapt to different complexity requirements. Without an extensible password rule engine, weak password anomalies are introduced into a system where strong passwords are in the majority, resulting in deviations from what is standard, conventional, or expected, making it difficult for average users to achieve a memorable password collection even without having the device being available for lookup.

Given a goal of minimizing replicas created to maintain a desired replication level, and at the same time maximizing accessibility to passwords whether in device storage or a user's memory, a more principled way of decentralizing password storage while providing support for ever-changing password renewals is needed in order to maintain long-term strong password conventions among trusted users and subject systems in an enterprise.

### SUMMARY OF THE INVENTION

Disclosed embodiments overcome shortfalls in the art by providing an enterprise password management system that may comprise a portable password device with the portable password device comprising microcontrollers (such as MCU), memory, hardware-clock expiration system, visual graphic displays, using LED and other means, API protocols for sending and receiving passwords with external systems, a detachable human interface input and communication systems such as Bluetooth Low Energy (such as BLE) communications.

Disclosed pseudorandom password expressions may be made extensible from the human interface input of the device so as to adapt to weaker password rules on subject systems that are incompatible with a device's own complexity requirements, and also to allow changing of a device's own complexity requirements in order to adapt to changing industry standards and environmental factors. A rule engine is used for the support of the pseudorandom expressions.

Various systems are disclosed and contemplated. For example, a password-age sensitive display system that ranks passwords according to password age, time to expiration, expiration status, and version of password complexity requirement. A password policy may require a regular change interval for passwords, in which case a password change may reset password age and time to expiration. A password policy may also require a regular change interval for password complexity requirement, e.g. a requirement of 3 numeric prefix replaced by a requirement of 3 numeric suffix, in which case actions may be configured to be automatically taken such as updated display order or sound played from speaker.

Various systems and websites may have inconsistent password rules, where complexity requirements may be different, as well as expiration policies may be different as well. The display system uses a phased approach to positively motivate a device owner to change passwords frequently without the system being intrusive or counterproductive. The display ranking is refreshed automatically based on the above factors to consistently rank those need attention higher. A device owner has the option to make change in phases instead of having to change all passwords in one session. This is especially beneficial for long-term support systems involving with large password sets, perhaps accumulated over a number of years.

A password rule engine may comprise a pseudorandom expression that includes two metacharacter-patterns on either end. The first metacharacter-pattern comprises mixed case characters, the mixed case characters intermixed with numbers, the numbers intermixed with ASCII special characters, the ASCII special characters comprising a purpose-based variable, the pseudorandom expression having a second metacharacter-pattern comprising mixed case characters, the mixed case characters intermixed with numbers and ASCII special characters. The second metacharacter-pattern of the pseudorandom expression contains a variable interpolation, where the variable interpolation refers to the corresponding value of the purpose-based variable. By using a flexible pseudorandom expression allows using of strong passwords that are memorable to average users.

Disclosed embodiments overcome shortfalls in the related art by presenting an unobvious and unique combination and configuration of methods and components to construct a secure password replication system around a designation server. The presently disclosed embodiments include a main module that comprises a microcontroller or central processing unit, memory, network communication, force measuring load cells, one or more trusted portable password devices, and additional components. The list of these various components is not exhaustive. The main module may comprise an open application programming interface (API) that allows communicating between trusted devices. When the designation server is notified of expiration of a password, a function in the server triggers actions in trusted portable password devices. This may be used to serve purpose of policy-driven password maintenance as well as discouraging forgotten designation from becoming stale.

In a disclosed embodiment, two single-use passwords are fully integrated into the designation of a password replica. An owner of a first device designates a steward using the designation server. The designated steward provides a first single-use password. The device owner provides a second single-use password. The first device encrypts a password replica using both the first and second single-use passwords, and then sends the replica to the server and the steward.

### BRIEF DESCRIPTION OF THE DRAWINGS

FIG. 1 depicts a perspective view of a disclosed portable password device;

FIG. 2 depicts a portable password device and its components;

FIG. 3 depicts a pseudorandom expression and metacharacter-patterns;

FIG. 4 depicts an enlarged plan view of a disclosed user interface or display system;

FIG. 5 depicts a schematic view of a disclosed password replication system embodiment and related communication systems;

FIG. 6 depicts a main module, a portable password device, and a communication system; and

FIG. 7 depicts a flowchart of an example method of password replication using single-use passwords.

### DETAILED DESCRIPTION

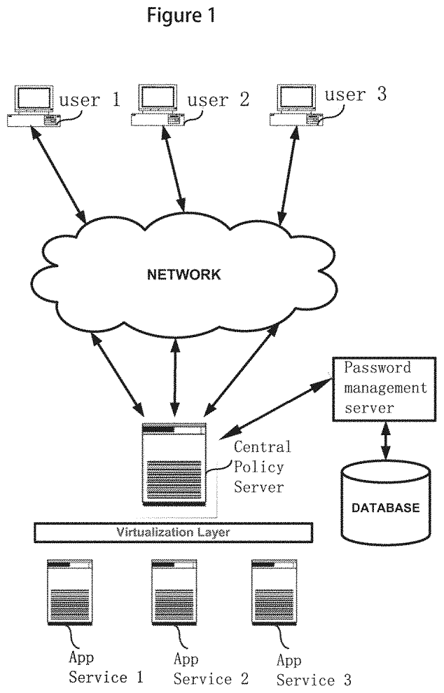

FIG. 1 depicts a perspective view of a disclosed portable password device 100 with a speaker cover section 110. The speaker cover 110 may protect in inner speaker.

Disclosed display systems include the first OLED application on a portable password device and provides programmable means to display any graphic content. The display may include various lights 120 for illumination and a two-way interaction using a touch sensor. The display may disclose or project subject system and owner information as well as password age, time to expiration, expiration status, version of password complexity requirement, and other reminder information may also be presented upon the display.

Interactivity and screen display features also include that ability of the system to determine an unplanned expiration of a password on an external subject system. The time of the expiration may be displayed upon the display system so that display ranking can be updated to bring the owner's attention to the reported incident.

A display may provide readable written notifications on the portable password device to alleviate the need for the device owner to need a smartphone or other device to read the notification. Human interaction with the portable password device is confirmed through the graphical display for password expression editing, password strength, reminder cancellation, renewal notifications and confirmations, and other items. The display is fully configurable via programming.

An inner or internal speaker 110 may be connected to a control center or other system accepting input from a system user. A speaker 110 may transmit sound to a wearer of the portable password device or a bystander near the device.

A disclosed speaker system may include a fully integrated speaker system that may include a resonant chamber integrated into a portable password device. In one disclosed embodiment, a small speaker 110 is integrated into the portable password device along with a resonant chamber. This configuration ensures the speaker 110 sounds are heard by the device owner in the surrounding area where the pet is located. The speaker 110 may play a variety of sounds to communicate instructions for policy-driven maintenance actions and procedures, and alerts for reminders as well as scheduled password renewals.

The graphical interface may include subject system identification information, password expiry information, such as password age, time to expiration, expiration status, version of password complexity requirement and other system information.

A new Sharing-Alert mode or Expiration-Alert mode provides new advantages in password replication. With a disclosed portable password device in use, a device owner may configure a series of duration and number of use, perhaps based on industry standards or policies. When the device determines that a predetermined time has passed and a password has not been renewed, then the portable password device switches the password to Expiration-Alert mode.

In a disclosed sharing-alert mode, the LED lights 120 begin flashing, the display displays the subject system's name, the owner's contact info, designated steward's contact info, and an audio message announcing the designation is played over the speaker 110 at high volume. This messaging repeated at a configurable frequency. The portable password device switches a password to sharing-alert mode when the device determines existing designations of the password, where the password is determined to be either in an expiration-alert mode or in an expired state.

A disclosed expiration-alert mode provides valuable information and features to device owners. In the normal use of any challenge-response authentication systems, a large password set accumulated over multiple years is known to become stale and be forgotten.

A disclosed portable password device is designed to assist the owner in finding the expiration information by ranking when one of two conditions exist. The first condition is for the portable password device that includes an expiry API for compatible subject systems to notify of expiration of a password. When a subject system sets to expire the password the expiry API is triggered indicating the password is put in an expired state. The second condition is if the portable password device does not sense any password renewal for more than a predetermined amount of time. If either of these conditions are met, then the portable password device's Expiration-alert mode is triggered. In this mode, the portable password device will go into alert mode and update password ranking according to password age, time to expiration, expiration status, and version of password complexity requirement. The display system will refresh several times after a predetermined hour during daytime overcomes shortfalls in the art as a device owner will know when to expect an audio and/or visual signal. The visual signal will be more noticeable at a predictable hour during the day.

Disclosed embodiments prevent rigid password rule limitation, display password expirations using a non-intrusive phased approach, may be extensible using a password expression to adapt to various subject systems and their inconsistent password rules.

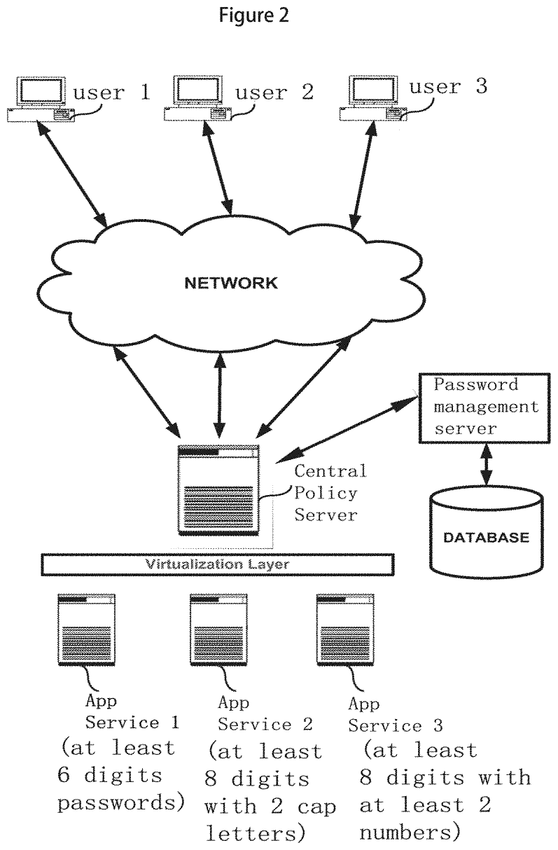

FIG. 2 depicts a portable password device having a hardware clock expiration system 220, a password replication system 230, a network communication system 240, a password rule engine 250, and a phased renewal system 260. A phased renewal system 260 may schedule password changes among time-based expirations based upon a predetermined amount of time and unplanned password resets triggered by an external subject system via API protocols. This feature overcomes shortfalls in the related art as the phased approach positively motivates a device owner to change passwords frequently without the portable password device being intrusive or counterproductive. A device owner has the option to make change in phases instead of having to change all passwords in the same phase or session. This is especially beneficial for a device owner working with a large LTS password set, perhaps accumulated over multiple years.

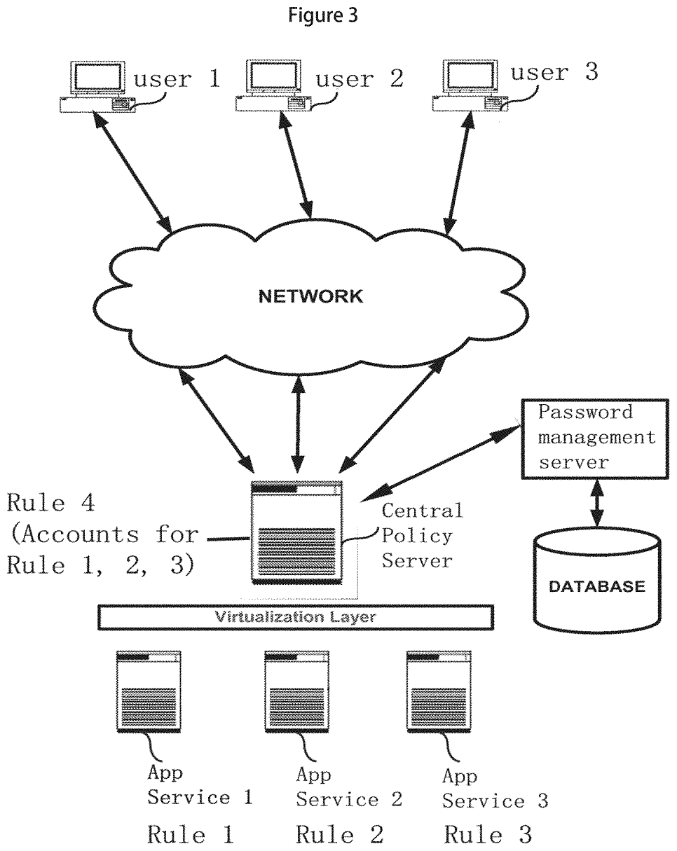

FIG. 3 depicts a perspective view of a pseudorandom expression 310 that includes two metacharacter-patterns on either end. The first metacharacter-pattern 320 comprises mixed case characters 322, the mixed case characters 322 intermixed with numbers 324, the numbers 324 intermixed with ASCII special characters 326, the ASCII special characters 326 comprising a purpose-based variable 328, the pseudorandom expression 310 having a second metacharacter-pattern 340 comprising mixed case characters 342, the mixed case characters 342 intermixed with numbers 344 and ASCII special characters 346. The second metacharacter-pattern 340 of the pseudorandom expression 310 contains a variable interpolation 348, where the variable interpolation 348 refers to the corresponding value of the purpose-based variable 328. By way of example, the depicted password may be changed from a first expression to a second expression, perhaps for renewing the password from an expired state, where both the first and the second passwords conform to the same expression. By using an extensible pseudorandom expression enables consistent strong password patterns that are memorable to average users, so as to help assure access to subject systems even when a password device becomes offline or disconnected.

A pseudorandom expression 310 embodiment is an extensible design that includes an assortment of potential permutations to enable password complexity level to be expanded by adding additional metacharacter-patterns. The assortment of permutations and expandable metacharacter-patterns allows the design to have unlimited complexity characteristics.

A disclosed pseudorandom expression 310 overcome shortfalls in the art in many ways, such as protecting stale passwords from brute force attacks by means of enforcing password renewals at regular intervals. The use of a purpose-based variable 328 introduces a deducible semi-randomness into a password convention that becomes more memorable to average users even when without access to a password device. The resulting value of the variable 328 and thus the containing expression remain secure enough to survive brute force attacks as the purpose is kept as a secret and is kept out of the password devices and system. The deduction logic itself is easily memorable to average users as it may stay the same over a long period of time, be applicable to various subject systems, and even survive across multiple renewal phases. Since the deduction logic is kept out of the system and known only to the device owner 560 and trusted stewards 570, it may be changed as often as the owner desires without any limitations imposed by the password system itself.

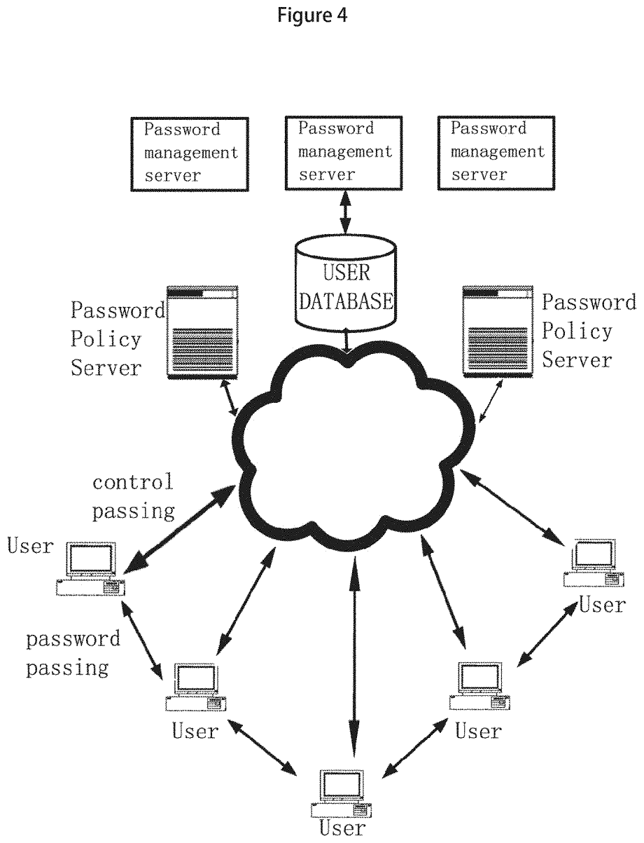

FIG. 4 depicts an enlarged plan view of a disclosed portable password device with a user interface or display system. The contents of the display screen include passwords as examples to illustrate metacharacter-pattern attached to a pseudorandom expression, with the metacharacter-pattern having a variable interpolation or other features to refer to the corresponding value of the purpose-based variable.

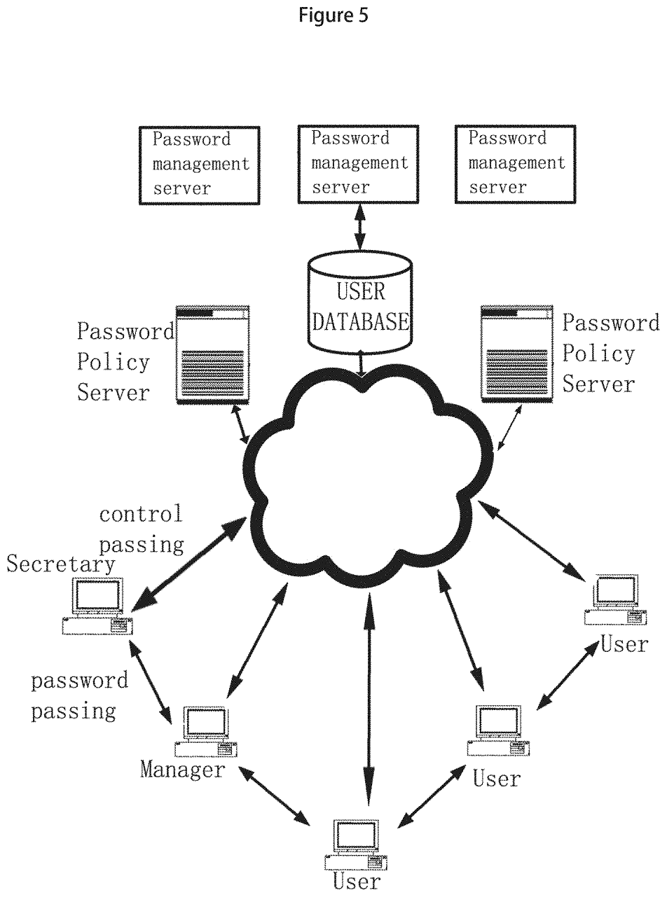

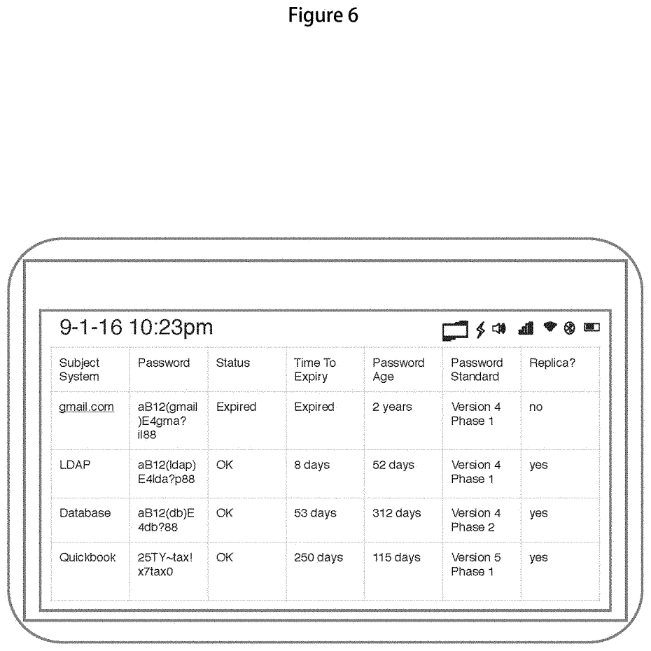

FIG. 5 and FIG. 6 depict a password replication system embodiment which may comprise a plurality of trusted portable password devices 540 and 550, a designation server 510 comprising a stakeholder directory 520 connected to the designation server 510, with the designation server 510 receiving designations destined for stewards 570 located in the stakeholder directory 520 with the received designations reported to a main module 610, the main module 610 comprising machine readable instructions stored upon non-volatile memory 620, the machine readable instructions read by a CPU 630, and the CPU 630 in communication with a network communication system 640.

FIG. 5 depicts a password replication system having two single-use passwords fully integrated into the designation of a password replica. The owner 560 of a first device designates a steward 570 by reporting to a designation server 510. The device owner 560 provides a first single-use password. The designated steward 570 provides a second single-use password. The first device 540 uses the first single-use password to encrypt a password to generate a replica. The designation server 510 receives the replica, uses the second single-use passwords to encrypt the replica, then sends the replica to the steward 570.

A disclosed password replication system overcomes shortfalls in the art in many ways, such as providing password replication in support of long-term system access and availability. In general, plain text passwords will not be transmitted between portable password devices and the replication system. The replication system will only send and receive password replicas in encrypted states, and will not retain any password replicas in its own storage to reduce potential attack vectors. Further, the replica sent from a portable password device 540 will include a purpose-based variable 328 to mask the original password for extra security measures.

A password replication system may comprise a communication system 530 communicating between the trusted portable password devices 540 and 550, the communication system 530 comprising designation API protocols.

The first single-use password is communicated to the owner of the second device over a separate owner-to-owner communication system 580 that is isolated from the network in which the designated server and the second portable password device are connecting to 530. This owner-to-owner communication system 580 may be a VPN, a dedicated point-to-point data link, SMTP email, verbal communication, etc.

FIG. 6 depicts a portable password device 650 having a display screen, speaker 656, a detachable human interface input system 660, with the detachable human interface input system 660 shown in an attached position. The portable password device 650 comprises machine readable instructions stored upon non-volatile memory 653, the machine readable instructions read by a CPU 652, the CPU 652 in communication with a display system 655, a speaker system 656, a hardware-clock 657 expiration system, a password replication system, a network communication system, and the detachable human interface input system 660.

Disclosed embodiments may include a Force Expiry function 624 used with a disclosed stakeholder directory system 520. When the password replication system's stakeholder directory 520 is notified of an expiration, the designation server signal triggers various actions in the trusted portable password devices 650 that can be used in long-term policy-driven password maintenance as well as discouraging forgotten designations from becoming stale. Other actions and/or policy-driven process improvements may also be encouraged.

A disclosed stakeholder directory may use a Force Expiry function 624 to notify a plurality of trusted portable password devices 650 upon receiving an expiration notification. The function triggers various actions in the plurality of trusted devices 650 that can be used in long-term policy-driven password maintenance as well as discouraging forgotten designation from becoming stale. Some examples of the various actions may include displaying warnings that are visible on screens, sounding alarms via speakers 110, putting replicas in expired state, etc.

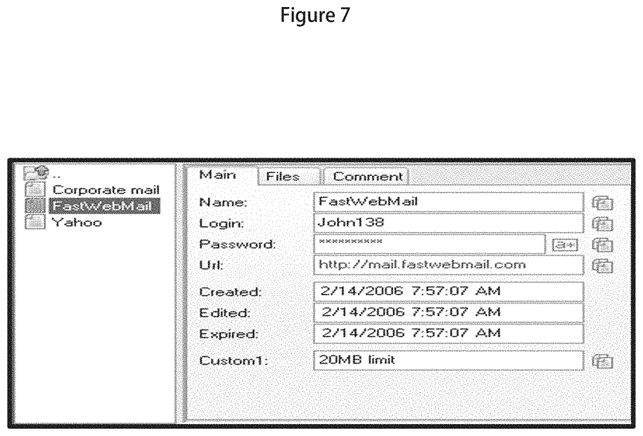

FIG. 7 depicts a designation server processing a password replication initiated from a first portable password device. A steward from the stakeholder directory is designated as a trusted party 710. The designation server triggers an action in the first device. The first device obtains a first single-use password from the owner to encrypt a password replica 720, and sends the encrypted password replica to the designation server 730. The steward provides to a second portable device a second single-use password 740, which the second device sends to the designation server via API protocols 750. The server further encrypts the received replica with the second single-use password to enhance protection for the replica in transit while being transferred to the trusted party 760. For maximum security protection, the first single-use password is never transmitted to either the designated server or the second portable password device, and thus the replica is always protected even in cases where both the designated server and the second portable password device are breached.

What is claimed:

1. A strong password by convention system for securely applying single-use passwords to distribute encrypted password replicas among designated password stewards, wherein phased password renewal is provided to support policy-based password change intervals, the system comprising:
a) a first portable password device comprising a first single-use password for encrypting a password replica;
b) a designation server comprising a stakeholder directory connected to the designation server, with the designation server receiving the password replica destined for a designated steward in the stakeholder directory with the received replicas reported to a main module, the main module comprising machine readable instructions stored upon non-volatile memory, the machine readable instructions read by a CPU, the CPU in communication with a network communication system;
c) the machine readable instructions further including a designation function using the reported replica in the stakeholder directory to trigger encrypting the reported replica using a second single-use password;
d) a second portable password device comprising the second single-use password, the second single-use password provided by the designated steward to the second portable password device in response to the triggering of the designation function; and
e) a first communication system communicating the password replica between the first and second portable password devices, the first communication system comprising designation API protocols for the communication; and
f) a second communication system communicating the first single-use password between the owner and the designated steward, wherein the first single-use password is transmitted on the second communication system but not transmitted on the first communication system, and the second communication system is disconnected from both the designated server and the second portable password device.

2. A portable password device with integrated electronic modular components used for password renewal and password replication, wherein a password is provided by an owner for long-term policy-driven maintenance, the device comprising:
a) machine readable instructions stored upon non-volatile memory, the machine readable instructions read by a CPU, the CPU in communication with a display system, a speaker system, a hardware-clock expiration system, a password replication system, a network communication system, and a detachable human interface input system;
b) a password rule engine comprising a pseudorandom expression having a first metacharacter-pattern comprising mixed case characters, the mixed case characters intermixed with numbers, the numbers intermixed with ASCII special characters, the ASCII special characters comprising a purpose-based variable, the pseudorandom expression having a second metacharacter-pattern comprising mixed case characters, the mixed case characters intermixed with numbers and ASCII special characters, the second metacharacter-pattern of the pseudorandom expression containing a variable interpolation, the variable interpolation referring to the corresponding value of the purpose-based variable; and
c) a phased renewal system scheduling password changes among time-based expirations and unplanned resets, the phased renewal system comprising phased renewal API protocols and password rule API protocols.

3. The system of claim 1 wherein the machine readable instructions further include a force expiry function to trigger warnings in the plurality of trusted portable password devices to discourage forgotten designations from becoming stale, wherein the force expiry function is triggered based on receiving of an expiration notification from a trusted portable password device.

4. The system of claim 3 wherein the warnings comprise vibration, sound, and LED flashing lights.

5. The system of claim 2 wherein the password replication system comprises a first single-use password provided by a designated steward, a second single-use password provided by the owner of the portable password device, and a replica encrypted by using the first ingle-use password and the second single-use password.

6. The system of claim 5 wherein the display system comprises the display of images and text to comprise a human interface output and wherein the speaker system comprises audio messages to further comprise the human interface output.

7. The system of claim 6 wherein signals generated by the hardware-clock expiration system and the password replication system are transmitted by the network communication system to the owner and used for the human interface output.

8. The system of claim 7 wherein the machine readable instructions further include a sharing-alert mode that is triggered upon the replica being placed in an expired state which in turn results in the display system displaying the subject system's name and the owner's profile and the speaker system announcing the subject system's name, and the network communication system sending a message to the owner.

9. The system of claim 8 wherein the machine readable instructions include an expiration-alert mode that is triggered upon either a) the password is placed in an expired state by a subject system, or b) the hardware-clock expiration system fails to report password renewal for a predetermined amount of time, with the expiration-alert mode placing the replica into the expired state, generating alarm sounds over the speaker, and flashing upon the LED lights for a predetermined amount of time.
